(19) United States
(12) Patent Application Publication
(10) Pub. No.: US 2017/0352173 A1
(43) Pub. Date: Dec. 7, 2017

(54) Image Processing Method and Device

(71) Applicant: Nokia Technologies Oy, Espoo (FI)

(72) Inventors: Marja Salmimaa, Tampere (FI); Toni Järvenpää, Akaa (FI); Miikka Vilermo, Siuro (FI); Arto Lehtiniemi, Lempäälä (FI)

(21) Appl. No.: 15/535,508

(22) PCT Filed: Dec. 15, 2015
(86) PCT No.: PCT/FI2015/050886

§ 371 Date: Jun. 13, 2017

(30) Foreign Application Priority Data
Dec. 22, 2014 (GB) 1422903.3

(51) Int. Cl. G06T 11/60; G06T 11/00; G06T 3/60; G02B 27/01; G06F 3/01; G06F 3/0484

(52) U.S. Cl. CPC G06T 11/60; G06T 3/60; G02B 27/0172; G06T 11/001; G02B 2027/014; G02B 2027/0138; G06F 3/04842; G06F 3/013; G06T 2200/24; G06T 2210/22; G06T 2210/62

(57) ABSTRACT

The invention relates to an imaging processing method comprising receiving (210) at least one input image, said at least one input image having been captured by at least one camera; receiving (220) at least one state parameter related to a user device, said user device comprising at least one display, said at least one display being at least partially transparent and operatively connected to said at least one camera. The at least one input image may be processed (230) based on the at least one received state parameter to produce at least one processed image. Alternatively or in addition, at least one image processing parameter indicative of the at least one received state parameter may be provided for processing (230) the at least one input image.

### BACKGROUND

Display technology has advanced markedly in the recent years. For example, a near-to-eye display (NED) is a wearable device that creates a display in front of the user's field of vision. A see-through display provides a display upon which a visual representation may be presented, and through which a user may also optically see the surrounding scene. A NED device may also comprise a camera for capturing images or video of the scene the user is viewing. Sharing such images with other users may sometimes be cumbersome.

Therefore, solutions are needed that enable the user to share captured images to other users.

### SUMMARY

Now there has been invented an improved method and technical equipment implementing the method, by which the above problems are alleviated. Various aspects of the invention include a method, an apparatus, a server system and a computer readable medium comprising a computer program stored therein, which are characterized by what is stated in the independent claims. Various embodiments of the invention are disclosed in the dependent claims.

The examples described here are related to near-to-eye displays (NED) with adjustable see-through and imaging capabilities. Here is proposed a method for capturing and sharing the authentic visual experience in form of an image. More precisely, tone, brightness and transparency adjusting are proposed for the content captured with NED integrated imaging sensors or cameras used in collaboration with NED based on the optical properties or state of the NED. Such adjusting may be done for both the captured surroundings and the embedded objects representing objects rendered on the display when the image was captured.

Captured content may include, in addition to the surroundings, the content shown on the display when the image was captured. Both the surroundings and the content, or the content only may be adjusted according to the NED sensor system data and NED shutter state to reflect the visual experience when the image was captured.

In other words, an imaging processing method is provided, comprising receiving at least one input image, said at least one input image having been captured by at least one camera; receiving at least one state parameter related to a user device, said user device comprising at least one display, said at least one display being at least partially transparent and operatively connected to said at least one camera. The at least one input image and/or embedded content (information shown on said at least one display) may be processed based on the at least one received state parameter to produce at least one processed image. Alternatively or in addition, at least one image processing parameter indicative of the at least one received state parameter may be provided for processing the at least one input image and/or embedded content.

### DESCRIPTION OF THE DRAWINGS

In the following, various embodiments of the invention will be described in more detail with reference to the appended drawings, in which

FIGS. 1a, 1 b and 1c
show examples of a communication arrangement with a server system, communication networks and user devices, and block diagrams for a server and user devices;

FIGS. 2a and 2b
show flowcharts of examples of image processing methods;

FIGS. 3a and 3b
show examples of image cropping and tilting;

FIG. 4 shows a flowchart of image processing chain;

FIGS. 5a, 5b, 5c and 5d
show examples of output images of the method; and

FIG. 6 shows an example of an image header file.

### DESCRIPTION OF EXAMPLES

In the following, several embodiments of the invention will be described in the context of near-to-eye displays with integrated imaging capabilities. It is to be noted, however, that the invention is not limited to such implementations. In fact, the different embodiments have applications in any environment where image processing is required, such as modifying image content based on prevailing conditions.

A near-to-eye display (NED) system as described here may comprise selective transmission of external light, e.g. an opacity filter or an environmental-light filter. Transparency of the NED with adjustable see-through capability may be changed e.g. according to the ambient illumination conditions, or the level of immersion the user prefers. Also, some coloring/tint may be created by a NED or NED's visor, or both the NED and the visor. These features have some implications on the visual experience of the user, e.g. how the user sees the color tones of the surroundings and the representations of the objects shown on the display.

NED integrated imaging sensors, or cameras used in collaboration with the NED, may capture the visual field of the NED user. It has been noticed here that, for example, the tint of the NED or/and the visor or changes in the NED shutter transparency do not affect the captured content. Furthermore, objects rendered on the display and visible to the user are not included in the captured content. Thus in some illumination conditions, and/or with different see-through settings, the captured content barely corresponds to the in situ visual experience. It has been noticed here that there is, therefore, a need for a solution that would provide a possibility to capture images corresponding to the real view through at least partially transparent display.

FIG. 1a shows a system and devices for processing images. In FIG. 1a, the different devices may be connected via a fixed wide area network such as the Internet 110, a local radio network or a mobile communication network 120 such as the Global System for Mobile communications (GSM) network, 3rd Generation (3G) network, 3.5th Generation (3.5G) network, 4th Generation (4G) network, 5th Generation network (5G), Wireless Local Area Network (WLAN), Bluetooth®, or other contemporary and future networks. Different networks are connected to each other by means of a communication interface, such as that between the mobile communication network and the Internet in FIG. 1a. The networks comprise network elements such as routers and switches to handle data (not shown), and radio communication nodes such as the base stations 130 and 132 in order for providing access for the different devices to the network, and the base stations 130, 132 are themselves connected to the mobile communication network 120 via a fixed connection or a wireless connection.

There may be a number of servers connected to the network, and in the example of FIG. 1a are shown servers 112, 114 for offering a network service for processing images to be shared to other users, for example, a social media service, and a database 115 for storing images and information for processing the images, and connected to the fixed network (Internet) 110. There are also shown a server 124 for offering a network service for processing images to be shared to other users, for example, and a database 125 for storing images and information for processing the images, and connected to the mobile network 120. Some of the above devices, for example the computers 112, 114, 115 may be such that they make up the Internet with the communication elements residing in the fixed network 110.

There may also be a number of user devices such as head mounted display devices 116, mobile phones 126 and smart phones, Internet access devices 128, personal computers 117 of various sizes and formats, and cameras and video cameras 163. These devices 116, 117, 126 and 128 may also be made of multiple parts. The various devices may be connected to the networks 110 and 120 via communication connections such as a fixed connection to the internet 110, a wireless connection to the internet 110, a fixed connection to the mobile network 120, and a wireless connection to the mobile network 120. The connections are implemented by means of communication interfaces at the respective ends of the communication connection.

In this context, a user device may be understood to comprise functionality and to be accessible to a user such that the user can control its operation directly. For example, the user may be able to power the user device on and off. The user may also be able to move the device. In other words, the user device may be understood to be locally controllable by a user (a person other than an operator of a network), either directly by pushing buttons or otherwise physically touching the device, or by controlling the device over a local communication connection such as Ethernet, Bluetooth or WLAN.

As shown in FIG. 1b, a user device 116, 117, 126, 128 and 163 may contain memory MEM 152, at least one processor PROC 153, 156, and computer program code PROGRAM 154 residing in the memory MEM 152 for implementing, for example, image processing. The user device may also have one or more cameras 151, 152 for capturing image data, for example video. The user device may also contain one, two or more microphones 157, 158 for capturing sound. It may be possible to control the user device using the captured sound by means of audio and/or speech control. The different user devices may contain the same, fewer or more elements for employing functionality relevant to each device. The user devices may also comprise a display 160 for viewing a graphical user interface, and buttons 161, touch screen or other elements for receiving user input. The user device may also comprise communication modules COMM1 155, COMM2 159 or communication functionalities implemented in one module for communicating with other devices.

FIG. 1b shows also a server device for providing image processing and storage. As shown in FIG. 1b, the server 112, 114, 115, 124, 125 contains memory MEM 145, one or more processors PROC 246, 247, and computer program code PROGRAM 248 residing in the memory MEM 145 for implementing, for example, image processing. The server may also comprise communication modules COMM1 149, COMM2 150 or communication functionalities implemented in one module for communicating with other devices. The different servers 112, 114, 115, 124, 125 may contain these elements, or fewer or more elements for employing functionality relevant to each server. The servers 115, 125 may comprise the same elements as mentioned, and a database residing in a memory of the server. Any or all of the servers 112, 114, 115, 124, 125 may individually, in groups or all together process and store images. The servers may form a server system, e.g. a cloud.

FIG. 1c shows examples of user devices for image capture and image processing. A head mounted display device 116 comprises one or more, for example two, displays 170 with adjustable see-through. A NED device may be configured, for example, as a pair of glasses worn on a user's head, or as a headband worn on a user's head, or contact lenses worn on user's eyes. The device may comprise imaging capabilities such as integrated cameras 171, 172. Alternatively or in addition, there may also be an external camera, for example a video camera 163 or a camera 173 integrated for example into a helmet 117. Cameras 163, 171, 172 and 173 may be operatively connected to the head mounted display device 116. The operative connection may be formed, for example, by galvanic connection or a wireless connection such as a radio connection. One of the cameras 171, 172 may be used to track the gaze of one eye of a user of the device 116. The device 116 may comprise means for image processing.

The system shown in FIG. 1c may include sensors 180, 181, 182, 183 such as ambient light sensor (ALS), 9 degrees of freedom (9DOF) or 6 degrees of freedom (6DOF) sensors, positioning sensors, orientation sensors, gyroscope, accelerometer, or any combination of these.

The device 116 may comprise a shutter unit for adjusting the transparency of the display 170. The device 116 may, for example, comprise a liquid crystal shutter 185 which may be configured to be switched on or off. In a switched-on state, a voltage is applied to a liquid crystal layer. This causes the liquid crystal shutter to become opaque, preventing light to traverse through the shutter 185. In a switched-off state, the liquid crystal shutter 185 is transparent, allowing the user of the device to see through the shutter 185. The transmittance of the shutter may be controlled by various methods. For example, the transmittance may be adjusted with a driving voltage applied to the shutter. When a high driving voltage is applied to the liquid crystals, the transmittance of liquid crystals increases. When a lower driving voltage is applied to the liquid crystals, the transmittance of liquid crystals decreases. Thus, it is possible to adjust the transparency of the display 170. Another way to adjust the transmittance of the shutter is to adjust a duty width of the driving voltage.

The device 116 may contain memory MEM 178, at least one processor PROC 176, 177, and computer program code PROGRAM 179 residing in the memory MEM 178 configured to, for example, process an input image captured by at least one camera 171, 172, 173. The user device may also comprise communication modules COMM1 174, COMM2 175 or communication functionalities for communicating with other devices.

The device 116 may comprise means for receiving at least one state parameter from the shutter 185 and/or from sensors 181, 182, 183, 184. In addition or alternatively, some or all of the state parameters may be calculated based on the shutter readings and/or the sensor readings.

In the following, some examples of image processing will be presented. For example, an image is captured using the camera 171. A user may make a selection of a processing option, i.e. the user may select if one wants to proceed with processing the image based on the state parameters that may be calculated based on the shutter readings and the sensor readings. As an output, a processed image may be obtained that may be shared for example in social media using a cell phone 126. The user may make a selection to share an original image. The user device 116 may have capabilities to share an image by, for example, connecting to an image sharing service on the internet.

As another example, a camera 173 integrated to a helmet may be used to capture an image. Next, the image may be received as an input image in the device 116 and processed based on the state parameters.

According to another example, an image may be captured using the camera 171 or 173. The image and the state parameters may be then provided by sending them to a receiving device, for example a cell phone 126. The image processing may be carried out in the receiving device. Yet another example may include a cloud formed, for example, of a server or a group of servers 112, 114, 115, 124, 125, in which cloud the image processing of the received input image may be carried out based on the received state parameters. The user may make a selection of a processing option i.e. the user may select if one wants to proceed with providing an instruction for the cloud or server(s) for processing the received input image based on the received state parameters.

FIG. 2a shows a flowchart of an image processing method. At the phase 210, at least one input image is received. The at least one input image may have been captured by at least one camera. The at least one input image may be received, for example, from an internal camera. Alternatively, it may, for example, be received from an external camera or a memory, for example an USB stick. The at least one input image may be sent from a user device to a server that receives the at least one input image. In other words, receiving may take place internally in a device, e.g. user device, server, or from another device, e.g., from user device to server. At the phase 220, at least one state parameter is received. Again, and generally, receiving may take place internally in a device, e.g. user device, server, or from another device, e.g., from user device to server. The at least one state parameter may be related to a user device comprising at least one display being at least partially transparent and operatively connected to the at least one camera. At the step 230, the at least one input image is processed based on the at least one received state parameter. At least one processed image may be produced as an output.

FIG. 2b shows a flowchart of an image processing method. At the phase 250, at least one input image is received. The at least one input image may have been captured by at least one camera. At the phase 260, at least one state parameter is received. The at least one state parameter may be related to a user device comprising at least one display being at least partially transparent and operatively connected to the at least one camera. At the phase 270, at least one image processing parameter being indicative of the at least one received state parameter is provided for processing the at least one input image. The at least one image processing parameter may be calculated from the received state parameters. The at least one image processing parameter may be written to a header of an image, for example.

Flowcharts in FIGS. 2a and 2b show examples of the image processing methods. There may be some other steps or phases between or after the phases or steps shown in FIGS. 2a and 2b. For example, white balance of the input image may be corrected before processing the input image based on the at least one received state parameter. The order of the steps may be different than that shown in FIGS. 2a and 2b. For example, at least one state parameter may be received before receiving an input image.

A see-through state of a display may originate from a reading of the shutter. The driving voltage and the see-through state may be connected to each other. The dependence between the driving voltage and the see-through state may be, for example, linear, piecewise linear, polynomial, or follow a logistic function. The dependence between the driving voltage and the see-through state may be different for different wavelengths of light. When the driving voltage applied to the shutter is known, the see-through state of the shutter may be calculated. The electro-optical response of the shutter may be defined in the specification by a manufacturer of the shutter. Transparency of an image may be created by using various methods, for example alpha compositing. Processing the at least one input image may comprise adjusting transparency of the at least one input image, wherein the adjusting is carried out based on a received state parameter, the received state parameter being a see-through state of a display.

A parameter may be received that is indicative of the tint or color of the shutter of a display and/or a visor. The tint of the shutter and/or a visor may be defined in the specifications of the components by the manufacturer and may be written into a memory on the device for example at manufacturing state or later. The tint of the shutter and/or the visor may change in response to the driving voltage. The driving voltage may be automatically adjusted based on the ambient illumination measured, for example, by ambient light sensors. When the electro-optic response of the shutter and/or visor is known, the tint of the shutter and/or visor may be defined based on the electro-optic response. The tint may be added by using various methods, for example alpha blending. Processing the at least one input image may comprise adding tint to the at least one input image, wherein the adding is carried out based on a received state parameter, the received state parameter being indicative of the visor tint and/or the tint of a shutter of a display.

The sensor readings may originate from, for example, ambient light sensors (ALSs). ALSs measure the amount of light in their environment. In smart phones, for examples, they allow for automatic dimming of a backlight of a display, when the light in the environment is sufficient for human eye. In the context of the NEDs, the measurements conducted using ALSs may be used for adjusting the transparency of the shutter or for adjusting brightness of the input image. Processing the at least one input image may comprise adjusting brightness of the at least one input image, wherein the adjusting is carried out based on a received state parameter, the received state parameter being indicative of ambient illumination.

Nine degrees of freedom (9DOF) sensors may include a 3-axis accelerometer, a 3-axis gyroscope, and a 3-axis magnetometer. 9DOF sensors may provide information on the user device 116 orientation at the moment an image is captured with the camera 171 in the user device 116. With this information, an image may be rotated or tilted to produce a straightened image of a crooked image.

For example, if a user wearing the user device 116 is keeping one's head in 45 degrees angle when capturing an image with camera 171, a horizon in the image may not be aligned correctly. In this case, the user may select the image to be tilted 45 degrees to produce an image where the horizon is straight in respect to the horizontal edge of the image. If the user makes a selection that the horizon is to be as originally captured and the camera 171 is integrated to the user device 116, no extra processing of the captured image is needed. If the user selects the horizon to be level with the edge and the camera is in a separate device, for example in the cell phone 126 or the video camera 163, the image may be tilted according to a 9DOF sensor in the separate device. If the user selects the horizon to be as originally captured and the camera is in a separate device the 9DOF tilt information from the user device 116 is subtracted from the 9DOF tilt information from the separate device. The difference in the tilt information may be used to tilt the captured image. It is possible to produce at least one tilted image of the at least one input image wherein the producing is carried out based on a received state parameter, the received state parameter being indicative of at least one user device orientation.

The tilted image may be cropped. FIG. 3a shows an example of cropping a tilted image. A captured image 310 is an image where, for example, a high building is not vertically straight. An image 312 is a tilted image produced from the image 310. The tilted image 312 is produced based on a received state parameter which is indicative of at least one user device orientation. An image 314 is a cropped image of the tilted image 312. If the user's gaze direction may be detected for example with a camera 172, the image 312 may be cropped taking into account the direction of the user's gaze. For example, if the user was looking towards left when capturing the image 310, cropping is made such that an image 316 is the cropped image. If the user was looking towards right when capturing the image 310, cropping is made such that an image 318 is the cropped image. Cropping may be carried out based on a received state parameter, said received state parameter being a gaze direction.

FIG. 3b shows an example of tilting a cropped image. A captured image 320 is an image where, for example, a high building is not vertically straight. An image 324 is a cropped image of the image 320. If the user's gaze direction may be detected for example with a camera 172, the image 320 may be cropped taking into account the direction of the user's gaze. For example, if the user was looking towards left when capturing the image 320, cropping is made such that an image 326 is the cropped image. If the user was looking towards right when capturing the image 320, cropping is made such that an image 328 is the cropped image. Cropping may be carried out based on a received state parameter, said received state parameter being a gaze direction. An image 322 is a tilted image produced from the image 326 or 328. The tilted image 322 is produced based on a received state parameter which is indicative of at least one user device orientation.

In the images shown in FIGS. 3.a and 3b a pixel grid may be aligned horizontally and vertically with respect to image edges.

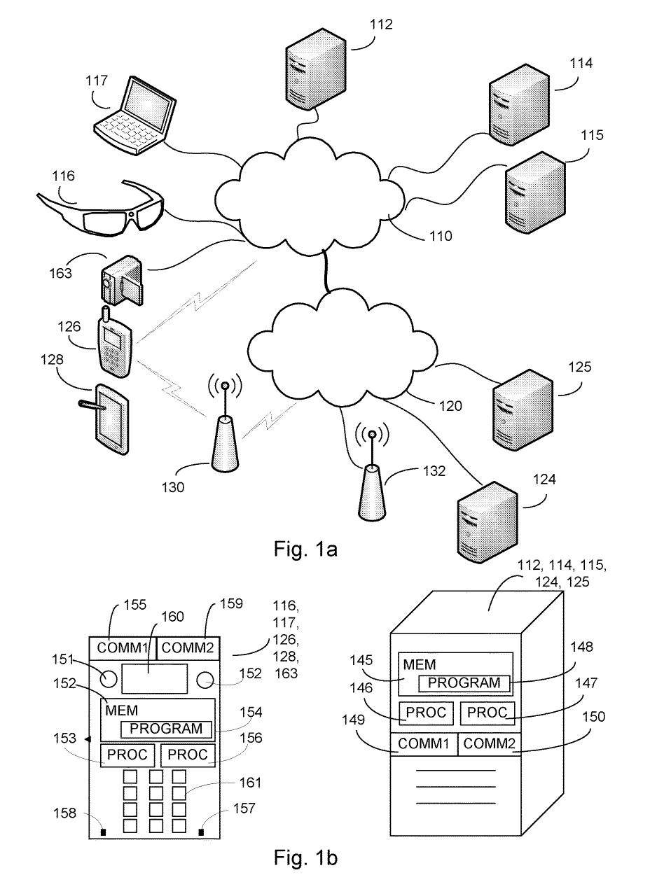

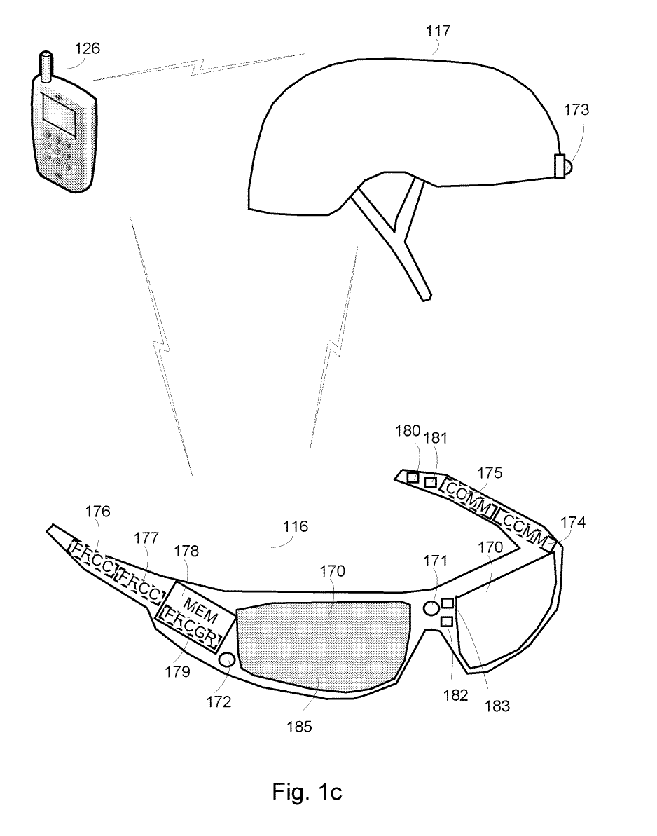

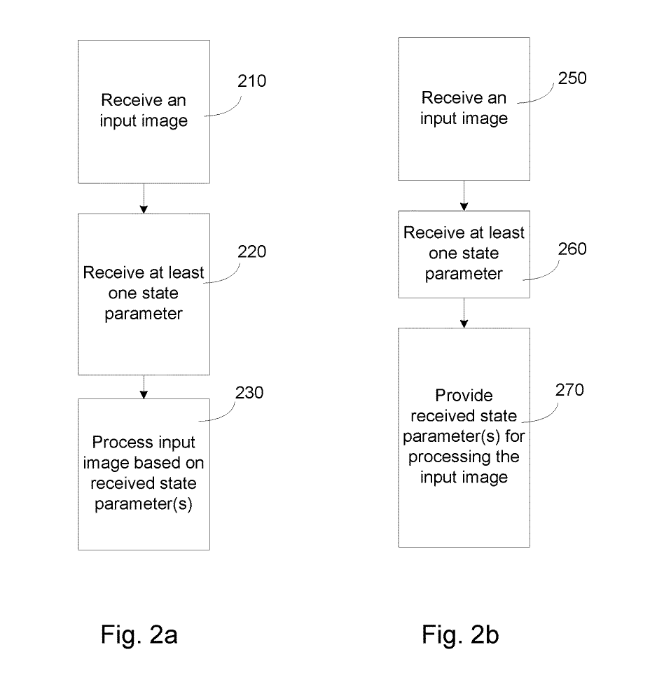

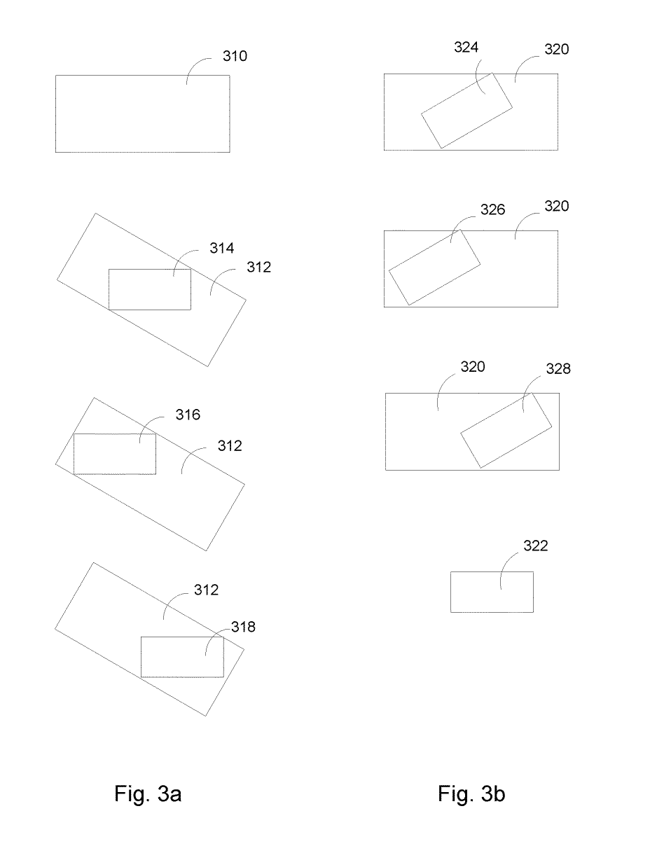

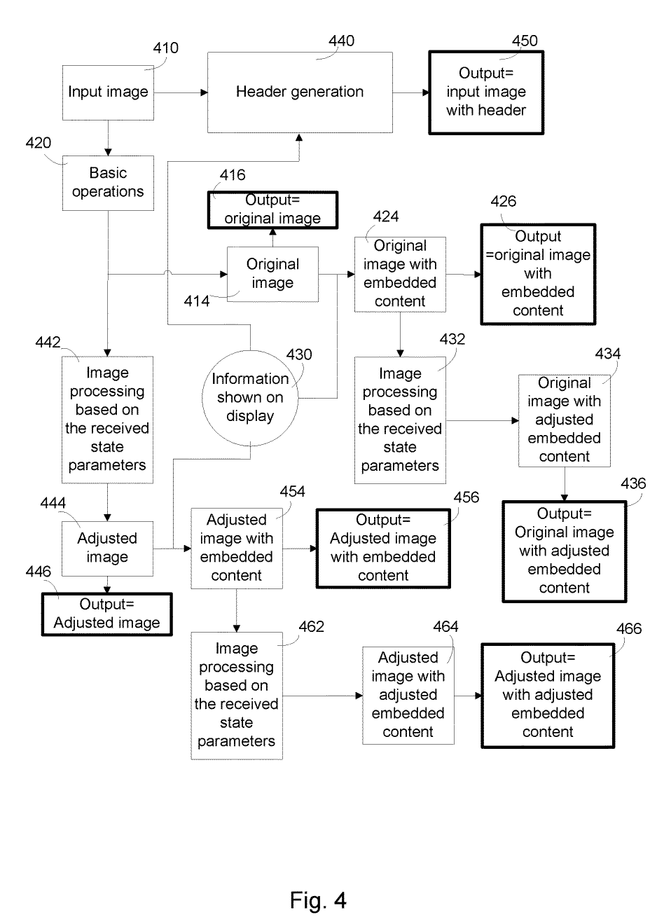

FIG. 4 shows a flowchart of image processing chain to produce one or more output images. The system may carry out the processing automatically according to pre-set user preferences. Camera settings may be defined by the user or by sensor readings and/or the see-through state of the shutter. For example, sensor readings and/or the see-through state of the shutter may affect real time control algorithms of the camera, such as auto focus, auto exposure, auto white balance, auto brightness and auto contrast. Blocks with bolded edges represent the output images of the system. All the image processing operations may be carried out in different layers. For example, an adjustment layer, which applies a common effect, such as brightness, to other layers may be used. As the effect is stored in a separate layer, the original layer is not modified, and it is easy to try different alternatives. It is also possible to apply the effect only to a part of the image.

An input image 410 may be captured by a camera. Then, the input image 410 may be processed using basic operations 420. These basic operations 420 may comprise, for example, white balance adjustment, gamma correction, color space correction, noise reduction, and geometrical distortion correction. A resulting image after basic operations 420 is an original image 414. The user may select the original image 414 to be the output 416.

The user may select the information shown on the display 430 to be superimposed to the original image 414 to achieve an original image with embedded content 424. The user may select the original image with embedded content to be the output 426.

The user may select the original image with embedded content 424 to be processed based on the received state parameters 432 to achieve an original image with adjusted embedded content 434. The user may select the original image with adjusted embedded content to be the output 436.

After processing the input image 410 using basic operations 420, the user may select to proceed with image processing based on the received state parameters 442. As a result, an adjusted image 444 is produced. The user may select the adjusted image 444 to be the output 446.

Alternatively, the user may select the information shown on the display 430 to be superimposed to the adjusted image 444 to achieve an adjusted image with embedded content 454. The user may select the adjusted image with embedded content to be the output 456.

The user may select the adjusted image with embedded content 454 to be processed based on the received state parameters 462. As a result, an adjusted image with adjusted embedded content 464 is produced. The user may select the adjusted image with adjusted embedded content 464 to be the output 466.

The user may select to have as an output the input image 410 with a header containing, for example, the image processing parameters indicative of the at least one received state parameter. The header may also contain the information shown on the display 430 to be embedded to the input image 410. Header generation may comprise calculation of the at least one image processing parameter indicative of the at least one received state parameter for processing the at least one input image 410. Header may also contain contextual data, such as date, time and location. The user may select the input image 410 with a header to be the output 450.

FIGS. 5a, 5b, 5c and 5d show examples of output images of the method according to the invention. An image 510 is an original image which is an input image processed with basic image processing operations, as described earlier. FIG. 5b shows an image with tint 520 of some color added (indicated with diagonal hatch) based on a received state parameter being indicative of a visor tint and/or a tint of a shutter of a display. FIG. 5c shows an original image 510 with embedded content 530. FIG. 5d shows an image with tint 540 of some color added (indicated with diagonal hatch) and embedded content 550 with adjusted transparency (indicated with diagonal cross hatch). Content embedded to the image may be information shown on the display while capturing an image. The information may include, for example, heartbeat of the user, ambient weather conditions, an image of a map showing a location where the user is, or information on the city where the user is. The image and the embedded content may be processed differently from each other based on the selection of the user.

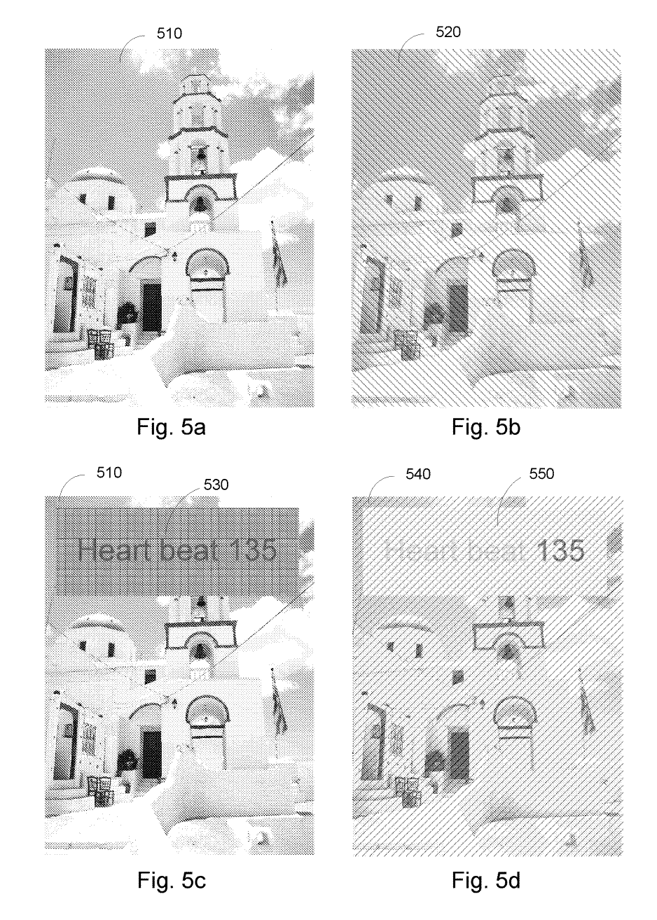

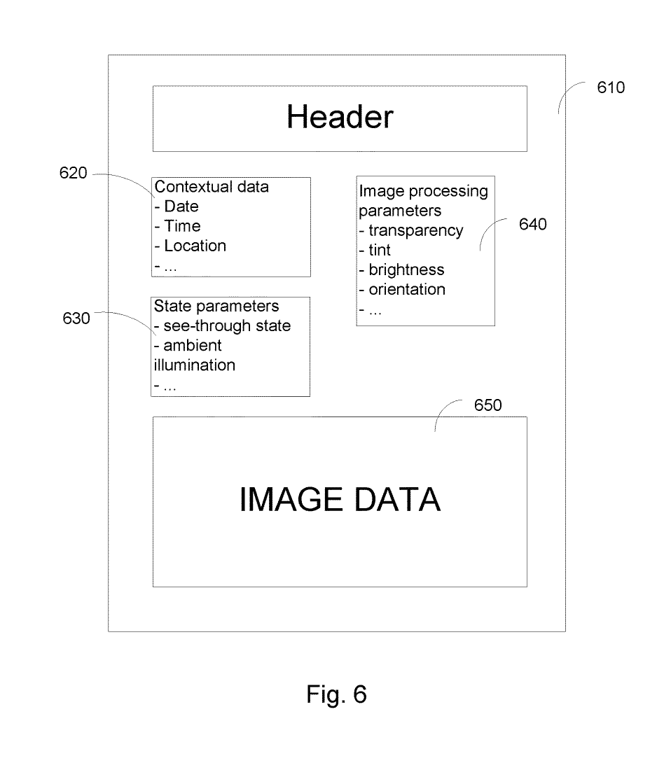

FIG. 6 shows an example of an image header file 610. The header file 610 may include contextual data 620 including, for example, date and time, when the image was captured, and location indicating where the image was captured. The header file 610 may also include state parameters obtained or calculated from the sensor readings from the shutter and different sensors in the system. The state parameters may include, for example, a see-through state of a display, visor tint, tint of a shutter of a display, ambient illumination, device orientation, or gaze direction.

Image processing parameters 640 are obtained or calculated from the state parameters and may include, for example, transparency, tint, brightness, device orientation, or gaze direction.

Image data 650 may be a raw image file usually containing minimally processed data from the image sensors. Alternatively image data 650 may contain coded image data or video data in various formats, for example, JPG, TIF, PNG, GIF, mp4, 3g2, avi, or mpeg. In addition, image data 650 may include the information shown on the display which may be embedded into the image. The various examples described above may be applicable to video technology. In this case, there will be requisites for video coding and decoding.

The various examples described above may provide advantages. Captured images may be processed in a way that authentic user experience is saved in form of an image. The method provides a new way to capture images and share them. An access to the original captured image (only surroundings) may be available to the user in case reproducing augmented information using the information shown on the display is not preferred by the user.

The various examples described above may be implemented with the help of computer program code that resides in a memory and causes the relevant apparatuses to carry out the invention. For example, a device may comprise circuitry and electronics for handling, receiving and transmitting data, computer program code in a memory, and a processor that, when running the computer program code, causes the device to carry out the features of an embodiment. Yet further, a network device like a server may comprise circuitry and electronics for handling, receiving and transmitting data, computer program code in a memory, and a processor that, when running the computer program code, causes the network device to carry out the features of an embodiment.

It is obvious that the present invention is not limited solely to the above-presented embodiments, but it can be modified within the scope of the appended claims.

1-51. (canceled)

52. A method, comprising:
receiving at least one input image, said at least one input image having been captured by at least one camera;
receiving at least one state parameter related to a user device, said user device comprising at least one display, said at least one display being at least partially transparent and operatively connected to said at least one camera; and
processing image data, said image data comprising one or both of the group of said at least one input image and embedded content, wherein said embedded content comprises information shown on said at least one display, based on the at least one received state parameter to produce at least one processed image.

53. The method according to claim 52, comprising:
receiving a selection of a processing option from a user; and
in response to receiving the selection, processing said image data based on the at least one received state parameter to produce at least one processed image.

54. The method according to claim 52, comprising:
adjusting transparency of said image data, wherein said adjusting is carried out based on a received state parameter, said received state parameter being a see-through state of a display.

55. The method according to claim 52, comprising:
adding tint to said image data, wherein said adding is carried out based on a received state parameter, said received state parameter being indicative of one or more from the group of:
visor tint; and
tint of a shutter of a display.

56. The method according to claim 52, comprising:
adjusting brightness of said image data, wherein said adjusting is carried out based on a received state parameter, said received state parameter being indicative of ambient illumination.

57. The method according to claim 52, comprising:
producing at least one tilted image of said image data, wherein said producing of the at least one tilted image is carried out based on a received state parameter, said received state parameter being indicative of at least one device orientation; and
cropping the at least one tilted image or said image data, wherein said image processing parameter for cropping is formed based on a received state parameter, said received state parameter being a gaze direction.

58. The method according to claim 52, comprising:
receiving a selection from a user;
in response to receiving the selection, embedding content to the at least one input image; and
processing the embedded content based on the at least one received state parameter.

59. A method, comprising:
receiving at least one input image, said at least one input image having been captured by at least one camera;
receiving at least one state parameter related to a user device, said user device comprising at least one display, said at least one display being at least partially transparent and operatively connected to said at least one camera; and
providing at least one image processing parameter indicative of the at least one received state parameter for processing image data, said image data comprising one or both of the group of said at least one input image and embedded content, wherein said embedded content comprises information shown on said at least one display.

60. The method according to claim 59, comprising:
receiving a selection of a processing option from a user; and
in response to receiving the selection, providing an instruction for processing said image data based on the at least one provided image processing parameter to produce at least one processed image.

61. The method according to claim 59, comprising:
forming an image processing parameter based on a received state parameter, said received state parameter being a see-through state of the display, for adjusting a transparency of said image data.

62. The method according to claim 59, comprising:
forming an image processing parameter based on a received state parameter, said received state parameter being one or more from the group of:
visor tint; and
tint of a shutter of the display;
said image processing parameter for adding tint to said image data.

63. The method according to claim 59, comprising:
forming an image processing parameter based on a received state parameter, said received state parameter being indicative of ambient illumination, for adjusting brightness of said image data.

64. The method according to claim 59, comprising:
forming an image processing parameter based on a received state parameter, said received state parameter being at least one device orientation, for producing at least one tilted image of said image data;
forming an image processing parameter for cropping the at least one tilted image or said image data, wherein said image processing parameter for cropping is formed based on a received state parameter, said received state parameter being a gaze direction.

65. An apparatus comprising at least one processor and memory including computer program code, the memory and the computer program code configured to, with the at least one processor, cause the apparatus to perform at least the following:
receive at least one input image, said at least one input image having been captured by at least one camera;
receive at least one state parameter related to a user device, said user device comprising at least one display, said at least one display being at least partially transparent and operatively connected to said at least one camera; and
process image data, said image data comprising one or both of the group of said at least one input image and embedded content, wherein said embedded content comprises information shown on said at least one display, based on the at least one received state parameter to produce at least one processed image.

66. The apparatus according to claim 65, further comprising computer program code, which executed by said at least one processor, causes the apparatus to perform:
receive a selection of a processing option from a user; and
in response to receiving the selection, process said image data based on the at least one received state parameter to produce at least one processed image.

67. The apparatus according to claim 65, further comprising computer program code, which executed by said at least one processor, causes the apparatus to perform:
adjust transparency of said image data, wherein said adjusting is carried out based on a received state parameter, said received state parameter being a see-through state of a display.

68. The apparatus according to claim 65, further comprising computer program code, which executed by said at least one processor, causes the apparatus to perform:
add tint to said image data, wherein said adding is carried out based on a received state parameter, said received state parameter being indicative of one or more from the group of:
visor tint; and
tint of a shutter of a display.

69. The apparatus according to claim 65, further comprising computer program code, which executed by said at least one processor, causes the apparatus to perform:
adjust brightness of said image data, wherein said adjusting is carried out based on a received state parameter, said received state parameter being indicative of ambient illumination.

70. The apparatus according to claim 65, further comprising computer program code, which executed by said at least one processor, causes the apparatus to perform:
produce at least one tilted image of said image data, wherein said producing of the at least one tilted image is carried out based on a received state parameter, said received state parameter being indicative of at least one device orientation; and
crop the at least one tilted image or said image data, wherein said cropping is performed based on a received state parameter, said received state parameter being a gaze direction.

71. The apparatus according to claim 65, further comprising computer program code, which executed by said at least one processor, causes the apparatus to perform:
receive a selection from a user;
in response to receiving the selection, embed content to the at least one input image; and
process the embedded content based on the at least one received state parameter.
